(19) United States
(12) Patent Application Publication
(10) Pub. No.: US 2006/0011376 A1
(43) Pub. Date: Jan. 19, 2006

(54) Multi-axial electrically conductive cable with multi-layered core and method of manufacture and use

(75) Inventors: David Charles Van Den Berg, Markleeville, CA (US); Robert Ivan Rose JR., Gardnerville, NV (US)

Correspondence Address: NIXON & VANDERHYE P.C., 901 NORTH GLEBE ROAD, 11TH FLOOR, ARLINGTON, VA, 22203, US

(73) Assignee: General Electric Company, Schenectady, NY (US)

(21) Appl. No.: 10/892,490

(22) Filed: Jul. 16, 2004

(51) Int. Cl. H01B 7/00

(52) U.S. Cl. 174/120 R

(57) ABSTRACT

A multi-axial electrically conductive cable having a multi-layered core. The multi-layered core comprises one layer of insulating dielectric material and at least one additional layer of insulating dielectric material. The multiple layers of the core are separable and allow the multi-axial electrically conductive cable to be utilized in several electrical connections of varying impedances and different sized connections.

### BACKGROUND OF THE INVENTION

This invention relates to a multi-axial electrically conductive cable with a multi-layered core that enables the cable to be utilized over a range of electrical impedance connections and diverse applications of the connections. In particular, this invention relates to a multi-axial cable with a multi-layered core and use of the cable to manufacture multi-impedance transducers for use in high temperature environments. This invention also relates to a method for manufacturing the multi-axial cable such that the cable fits in several sized electrical connections.

A coaxial electrically conductive cable method of manufacture is disclosed in U.S. Pat. No. 4,508,585 to Frakes. The use of coaxial cable for the transmission of high frequency electrical signals and like applications is well known in the art. Typically, a multi-axial electrically conductive cable, specifically coaxial cable, comprises an inner conductor encased in an annular layer of electrically insulating dielectric material. An outer electrical conductor is typically disposed about the electrically insulating material layer. This outer electrical conductor has several uses, including as an electrical ground or for the transmission of low frequency electrical signals.

Standard multi-axial electrically conductive cable, as typically used in the industry, is sold in fixed diameters for varying electrical connections and applications. These electrical connections vary by, for example, impedance with the diameter of the cable dependent upon the impedance of the connection in an electrical application. For example, a typical 75 ohm multi-axial electrically conductive cable has a smaller diameter than a typical 95 ohm multi-axial electrically conductive cable. These fixed diameter sizes create difficulties with manufacturing costs and flexibility and with inventory control, because a separate electrically conductive cable is needed for each different electrical connection which size varies with impedance.

Therefore, a need exists for an electrical cable with a construction that allows one cable to be utilized in several electrical connection applications to lower manufacturing costs and increase manufacturing flexibility of electrical devices and to enable inventory control of spare parts in electrical device manufacturing and/or services. A further need exists to develop a method of manufacture of the multi-axial electrically conductive cable with a multi-layered core to enable the multiple layers of the core to be separated. Finally, a need exists for stripping and crimping a multi-axial cable to ensure accurate installation in and attachment to an electrical device.

### BRIEF DESCRIPTION OF THE INVENTION

Accordingly, a multi-axial electrically conductive cable, as embodied by the invention, comprises a center conductor; a multi-layered, non-conducting dielectric core, the multi-layered, non-conducting dielectric core surrounding the center conductor; at least one conductive shield surrounding the multi-layered, non-conducting core; and at least one non-conducting insulator surrounding the at least one conductive shield.

A further aspect of the invention, provides a method of manufacture of a multi-axial electrically conductive cable. The multi-axial electrically conductive cable, as embodied by the invention, comprises a center conductor, a multi-layered, non-conducting dielectric core, at least one conductive shield, and at least one non-conducting insulator. The method, as embodied by the invention, comprises steps of providing center conductor; providing a multi-layered, non-conducting dielectric core; providing at least one conductive shield; and providing at least one non-conducting insulator. The step of providing a multi-layered, non-conducting dielectric core comprises providing a first layer of dielectric material and at least one additional layer of dielectric material, and the at least one additional layer is separable from the first layer of dielectric material.

A yet further aspect of the invention includes a method of use of a multi-axial electrically conductive cable. The cable, as embodied by the invention, is provided with a multi-layered core, a center conductor, a multi-layered non-conducting dielectric core surrounding the center conductor. The multi-layered non-conducting dielectric core comprises a first layer of dielectric material and at least one additional layer of dielectric material. The cable, as embodied by the invention, is provided with at least one conductive shield surrounding the multi-layered non-conducting dielectric core, and at least one non-conducting insulator. The method, as embodied by the invention, comprises the steps of determining a length for the outer conductor; removing the outer insulation to the length thus exposing the outer conductor; determining a length of inner insulation; removing outer conductor to expose the multi-layered non-conducting dielectric core; determining a length for inner conductor; removing the multi-layered non-conducting dielectric core to expose the inner conductor; and crimping braided outer conductor.

Another aspect of the invention sets forth a multi-axial electrically conductive cable comprising a center conductor; a multi-layered, non-conducting dielectric core, the multi-layered, non-conducting dielectric core surrounding the center conductor; at least one conductive shield surrounding the multi-layered, non-conducting core; and at least one non-conducting insulator surrounding the at least one conductive shield. The multi-layered non-conducting dielectric core comprises a first layer of dielectric material and at least one additional layer of dielectric material. The multi-layered non-conducting core comprises a first layer of non-conducting dielectric material selected from a group comprising at least one of polytetrafluoroethylene, fluorinated ethylene propylene, ethylene tetrafluoroethylene copolymer, perfluoroalkoxy copolymer, polyvinylidene fluoride, fluoropolymer, polyvinyl chloride, and polyurethane. Also, the at least one additional layer of the multi-layered non-conducting core is selected from a group comprising at least one of fluorinated ethylene propylene, ethylene tetrafluoroethylene copolymer, perfluoroalkoxy copolymer, polyvinylidene fluoride, fluoropolymer, polyvinyl chloride, and polyurethane. The at least one additional layer of the multi-layered non-conducting core is separable from the first layer of dielectric material.

### BRIEF DESCRIPTION OF THE DRAWINGS

FIG. 1 is a schematic diagram of a multi-axial electrically conductive cable with multi-layered core.

FIG. 2 is a cross-sectional view of the multi-axial electrically conductive cable in this invention.

FIG. 3 illustrates the steps of the stripping and crimping process for the multi-axial electrically conductive cable with multi-layered core.

### DETAILED DESCRIPTION OF THE INVENTION

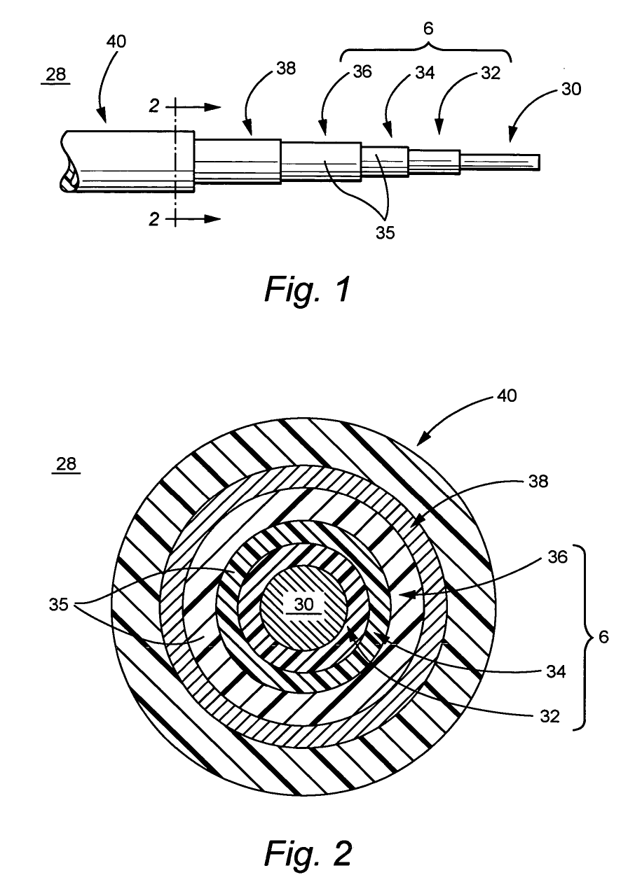

FIGS. 1 and 2 schematically illustrate a multi-axial electrically conductive cable 28 comprising an inner conductor 30, a first layer of dielectric insulating material 32, at least one second layer of dielectric insulating material 35, at least one outer conductor 38, and at least one outer insulator or “jacket” 40. In one embodiment, the layers of dielectric insulating material 32, 34, 36 include at least two separable layers comprising any suitable dielectric material. In this embodiment, the multi-axial electrically conductive cable 28 comprises of a first layer 32 of insulating dielectric material and a second layer of insulating dielectric material 34.

The exemplary multi-axial cable in this embodiment comprises a coaxial cable 28 that is utilized in 75 ohm and 95 ohm electrical assembly connections in high temperature environments. The cable 28 comprises an inner conductor 28 made of seven strands of silver-covered, annealed copper steel wire. The overall diameter of the core conductor is about 0.012 inch. This diameter and the dimensions and values provided herein are merely exemplary of the cable as embodied by the invention and are not meant to limit the invention mentioned herein. Other dimensions and values are within the scope of the invention.

Next, the cable in the exemplary embodiment comprises an insulative core 6 surrounding the inner conductor 30. This core 6 comprises two separable layers. The first layer 32 of the core 6 comprises solid extruded polytetrafluoroethylene with an overall diameter of about 0.068 inches. The second layer 34 of the core comprises heavy-metal free, extruded fluorinated ethylene propylene with an overall diameter of about 0.12 inches. These materials and others provided herein are merely exemplary of the cable as embodied by the invention and are not meant to limit the invention mentioned herein. Other materials for the insulative core for use in different environments are within the scope of the invention.

Finally, the exemplary cable 28 comprises an outer conductor 38 comprising single braid, hard drawn silver-covered, copper clad steel wire with an overall diameter of about 0.125 inches. The exemplary cable 28 is enclosed in extruded fluorinated ethylene propylene with a will thickness of about 0.010 inches. The overall diameter of the cable is about 0.138 inches.

The inner conductor 30 is used to transmit high frequency or low frequency electrical signals or direct current. This conductor 30 may be a solid metal or twisted wire. The inner conductor 30 is formed from an electrically conductive material. In this embodiment, the inner conductor 30 comprises 7-stranded steel wire clad with copper and covered with silver.

The insulative layers 32, 34, 36 comprise the “core” 6 of the multi-axial electrically conductive cable 28 in this embodiment. These insulative layers 32, 35 are formed from suitable non-conducting dielectric material, and are separable because of a manufacturing method embodied by the invention and discussed hereinafter. In this embodiment, the core 6 of the multi-axial electrically conductive cable comprises two layers.

The first non-conducting dielectric insulative layer 32 is selected from a group comprising at least one of polytetrafluoroethylene, fluorinated ethylene propylene, ethylene tetrafluoroethylene copolymer, perfluoroalkoxy copolymer, polyvinylidene fluoride, fluoropolymer, polyvinyl chloride, and polyurethane. The materials listed here and throughout the rest of this specification are applicable for multi-axial cables used in high temperature environments. However, the first layer 32 and the other layers of the core can comprise any other suitable non-conducting dielectric material, depending on the use of the cable in, for example, a low temperature environment. In this embodiment, the first layer 32 of dielectric insulative material comprises polytetrafluoroethylene.

The core also contains at least one additional layer of non-conducting dielectric insulative material 35 formed from a group comprising at least one of fluorinated ethylene propylene, ethylene tetrafluoroethylene copolymer, perfluoroalkoxy copolymer, polyvinylidene fluoride, fluoropolymer, polyvinyl chloride, and polyurethane. In this embodiment, this additional layer 34 comprises fluorinated ethylene propylene.

The at least one additional layer of non-conducting dielectric material 35 is separable from the first layer of non-conducting dielectric material 32. This at least one additional layer 35 should be separable from the layer 32 below it to allow the cable to be stripped and crimped to fit into the desired electrical connection. This separability can be achieved by utilizing a releasing agent between the first non-conducting dielectric layer 32 and the at least one additional dielectric layer 35, manufacturing process, or a combination of releasing agent or manufacturing process.

In this embodiment, separability of the core 6 is achieved by a fluoropolymer extrusion manufacturing process. The separability of the first layer 34 and the at least one additional layer 35 is achieved because the melting point of the first layer 32 is higher than the melting point of the second layer 34.

The core 6 can comprise several layers 35 of insulating dielectric material to allow the multi-axial electrically conductive cable 20 to be utilized in various electrical connections. Each additional layer should be separable from the layer beneath it and able to withstand processing conditions if another dielectric material layer is deposited on it. The number of layers of non-conducting dielectric material 35 is only limited by an amount that enables the cable 28 to be practically usable.

The multi-axial electrically conductive cable 28 also comprises at least one conductive shield 38. This outer conductor layer 38 is utilized to transmit high frequency or low frequency electrical signals, to direct current, or to ground an electrical device. This outer conductor layer can comprise more than one layer of outer conductor as disclosed in Van Den Berg '884. Additionally, this outer conductor can be selected from at least one of a group comprising braided wire, solid metal, or foil. In this embodiment, the outer conductor 38 comprises silver-covered, copper-clad braided steel wire.

The last layer on the coaxial cable 28 is a non-conducting insulator or “jacket”40. This jacket protects the coaxial cable 28 and keeps the cable 28 electrically isolated so that the cable 28 or the electrical assembly is not shorted. This jacket can be selected from a group comprising at least one of polytetrafluoroethylene, fluorinated ethylene propylene, ethylene tetrafluoroethylene copolymer, perfluoroalkoxy copolymer, polyvinylidene fluoride, fluoropolymer, polyvinyl chloride, and polyurethane. In this embodiment, the outer insulator 40 comprises fluorinated ethylene propylene.

In another embodiment, a method of manufacture of a multi-axial electrically conductive cable 28 is provided. The method of manufacture provides a center conductor 30, a multi-layered, non-conducting dielectric core 6, at least one conductive shield 38 and at least one non-conducting insulator 40. The method of manufacture provides for a core 6 comprising separable layers. The method of manufacture for the core 6 comprises at least one of extrusion, tape wrapping, weaving, or any other method of manufacture such that the layers of the core 6 are separable. In this embodiment, the method of manufacture for the core 6 is extrusion.

The method of manufacture also provides for a core 6 formed from at least one of a group comprising polytetrafluoroethylene, fluorinated ethylene propylene, ethylene tetrafluoroethylene copolymer, perfluoroalkoxy copolymer, polyvinylidene fluoride, fluoropolymer, polyvinyl chloride, and polyurethane. In this embodiment, the first layer 32 of the core 6 comprises polytetrafluoroethylene and the second layer of the core 34 comprises fluorinated ethylene propylene.

The method of manufacture determines whether the first layer of dielectric material 32 and the at least second layer of dielectric material 35 is separable. In one example, a releasing agent is used between the first dielectric layer 32 and the at least one additional layer 35. In another example, the first layer 32 is tape wrapped separately than the at least one additional layer 35. In a different example, the first layer 32 is woven separately from the second layer 36. In this embodiment, because the extrusion process is utilized with a fluoropolymer, the first layer 32 comprises a material of a higher melting point than the second layer 34.

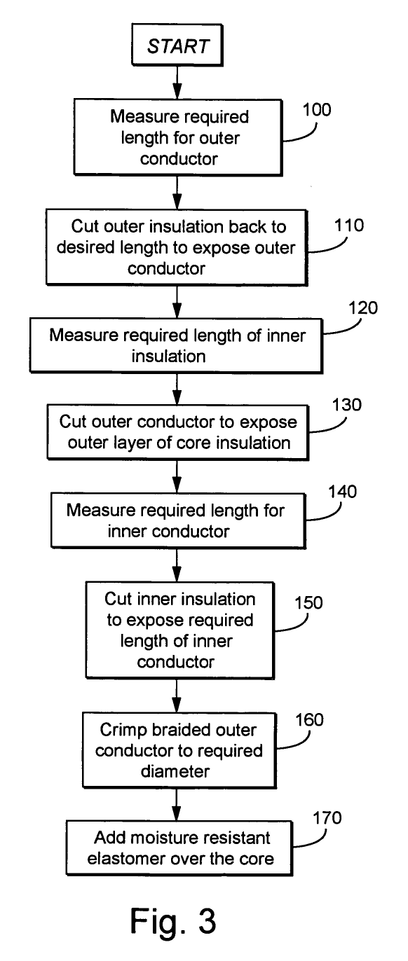

FIG. 3 illustrates a method for stripping and crimping the multi-layered core of the multi-axial electrically conductive cable 28 discussed in this invention. In step 100, the method involves first measuring the required length for the outer conductor 38 for both higher and lower impedance connections. Tooling is then used to cut the outer insulation 40 back to expose the desired length of the outer conductor 38, in step 110.

Next, the required length of inner insulation 32, 35 is measured to install an elastomer seal, in step 120. An exemplary elastomer seal is disclosed in Van den Berg '884. In step 130, the outer conductor 38 is cut to expose the outer layer 36 of core insulation. The required length for the inner conductor 30 is then measured in step 140, and the inner insulation 32, 35 is cut to expose the required length of inner conductor 30 in step 150. The method ends by crimping the outer conductor 38 to the required diameter for larger impedance assemblies in step 160. For lower impedance connections, the outer conductor 38 may have to be crimped at least one additional time to fit into a smaller assembly. Finally, a moisture resistant elastomer seal is added over the core 6 to protect the cable 28. The coaxial cable 28 is now ready to be connected to an electrical device as disclosed in Frakes '585.

The multi-axial electrically conductive cable with a multi-layered core, as embodied by the invention, has been developed to lower costs, to increase flexibility, and to enhance inventory control of spare parts in electrical device manufacturing operations. The multi-layered core has a first layer of insulating dielectric material and at least one additional layer of insulating dielectric material. By making a multi-layered core, it is feasible to use one cable in several electrical connections that vary by impedance or size.

While various embodiments are described herein, it will be appreciated from the specification that various combinations of elements, variations or improvements therein may be made by those skilled in the art, and are within the scope of the invention.

1. A multi-axial electrically conductive cable comprising:
a center conductor, wherein said conductor is adapted to transmit a first electrical signal;
a multi-layered, non-conducting dielectric core, the multi-layered, non-conducting dielectric core surrounding the center conductor;
at least one non-grounded conductive shield surrounding the multi-layered, non-conducting core, wherein said shield is adapted to transmit a second electrical signal; and
at least one non-conducting insulator surrounding the at least one conductive shield.

2. The multi-axial electrically conductive cable of claim 1, wherein the center conductor comprises an electrically conductive material.

3. The multi-axial electrically conductive cable of claim 1, wherein the center conductor comprises at least one of a solid metal layer and a twisted wire layer.

4. The multi-axial electrically conductive cable of claim 1, wherein the center conductor comprises 7-stranded steel wire clad with copper and covered with silver.

5. The multi-axial electrically conductive cable of claim 1, wherein the multi-layered non-conducting dielectric core comprises a first layer of dielectric material and at least one additional layer of dielectric material.

6. The multi-axial electrically conductive cable of claim 5, wherein said first layer of non-conducting dielectric material is selected from a group consisting of polytetrafluoroethylene, fluorinated ethylene propylene, ethylene tetrafluoroethylene copolymer, perfluoroalkoxy copolymer, polyvinylidene fluoride, fluoropolymer, polyvinyl chloride, and polyurethane.

7. The multi-axial electrically conductive cable of claim 5, wherein said first layer of dielectric material comprises polytetrafluoroethylene.

8. The multi-axial electrically conductive cable of claim 5, wherein the at least one additional layer is selected from a group consisting one of fluorinated ethylene propylene, ethylene tetrafluoroethylene copolymer, perfluoroalkoxy copolymer, polyvinylidene fluoride, fluoropolymer, polyvinyl chloride, and polyurethane.

9. The multi-axial electrically conductive cable of claim 5, wherein the at least one additional layer comprises fluorinated ethylene propylene.

10. The multi-axial electrically conductive cable of claim 5, wherein the at least one additional layer is separable from the first layer of dielectric material.

11. The multi-axial electrically conductive cable of claim 5, wherein the at least one additional layer is separable because of method of manufacture.

12. The multi-axial electrically conductive cable of claim 5, wherein the first layer and the at least one additional layer are formed by a process selected from the group comprising extrusion, tape wrap, and weave process.

13. The multi-axial electrically conductive cable of claim 5, wherein the first layer and the at least one additional layer are formed by extrusion.

14. The multi-axial electrically conductive cable of claim 5, wherein the melting point of the at least one additional layer is lower than the melting point of the first layer.

15. The multi-axial electrically conductive cable of claim 5, wherein the melting point of fluorinated ethylene propylene is lower than the melting point of polytetrafluoroethylene.

16. The multi-axial electrically conductive cable of claim 5, wherein each layer of the multi-layered non-conducting dielectric core can be stripped and crimped to fit different electrical assemblies.

17. The multi-axial electrically conductive cable of claim 1, wherein the at least one conductive shield is comprised of an electrically conductive material.

18. The multi-axial electrically conductive cable of claim 17, wherein the conductive shield comprises silver-covered, copper-clad steel wire.

19. The multi-axial electrically conductive cable of claim 17, wherein the at least one conductive shield is conductive and selected from the group consisting of braided wire, solid metal, and foil.

20. The multi-axial electrically conductive cable of claim 17, wherein the at least one conductive shield comprises silver-covered, copper-clad braided steel wire.

21. The multi-axial electrically conductive cable of claim 17, wherein the at least one conductive shield comprises at minimum one shield to form a coaxial cable.

22. The multi-axial electrically conductive cable of claim 1, wherein the at least one non-conducting insulator is selected from a group consisting one of polytetrafluoroethylene, fluorinated ethylene propylene, ethylene tetrafluoroethylene copolymer, perfluoroalkoxy copolymer, polyvinylidene fluoride, fluoropolymer, polyvinyl chloride, and polyurethane.

23. The multi-axial electrically conductive cable of claim 22, wherein the at least one non-conducting insulator comprises fluorinated ethylene propylene.

24. A method of manufacture of a multi-axial electrically conductive cable, the multi-axial electrically conductive cable comprising a center conductor, a multi-layered, non-conducting dielectric core, at least one conductive shield, and at least one non-conducting insulator, the method comprising:
providing center conductor;
providing a multi-layered, non-conducting dielectric core;
providing at least one conductive shield; and
providing at least one non-conducting insulator; wherein the step of providing a multi-layered, non-conducting dielectric core comprises providing a first layer of dielectric material and at least one additional layer of dielectric material, and the at least one additional layer is separable from the first layer of dielectric material.

25. The method of claim 24, wherein the step of providing the multi-layered, non-conducting dielectric core is process selected from the group comprising least one of extrusion, tape wrapping, and weaving.

26. The method of claim 24, wherein the step of providing the multi-layered, non-conducting dielectric core comprises forming the multi-layered, non-conducting dielectric core from a dielectric material selected from the group comprising at least one of polytetrafluoroethylene, fluorinated ethylene propylene, ethylene tetrafluoroethylene copolymer, perfluoroalkoxy copolymer, polyvinylidene fluoride, fluoropolymer, polyvinyl chloride, and polyurethane.

27. The method of claim 24, wherein the step of providing the multi-layered, the first layer of dielectric material and the at least one additional layer of dielectric material.

28. The method of claim 24, wherein the step of providing the multi-layered, non-conducting dielectric core comprises providing the first layer of dielectric material having a higher melting point than and the melting point of the at least one additional layer of dielectric material.

29. A method of use of a multi-axial electrically conductive cable with multi-layered core, the multi-axial electrically conductive cable with multi-layered core comprising a center conductor, a multi-layered non-conducting dielectric core surrounding the center conductor, the multi-layered non-conducting dielectric core comprising a first layer of dielectric material and at least one additional layer of dielectric material, at least one conductive shield surrounding the multi-layered non-conducting dielectric core, and at least one non-conducting insulator, the method comprising:
determining a length for the outer conductor;
removing the outer insulation to the length thus exposing the outer conductor;
determining a length of inner insulation;
removing outer conductor to expose the multi-layered non-conducting dielectric core;
determining a length for inner conductor;
removing the multi-layered non-conducting dielectric core to expose the inner conductor;
crimping braided outer conductor.

30. The method of claim 29, wherein the steps of said removing provides the cable for varying electrical assemblies of different amperages.

31. The method of claim 29, further comprises providing an elastomer seal that protects the cable against moisture.

32. A multi-axial electrically conductive cable comprising:
a center conductor adapted to transmit a first electrical signal;
a multi-layered, non-conducting dielectric core, the multi-layered, non-conducting dielectric core surrounding the center conductor;
at least one non-grounded conductive shield surrounding the multi-layered, non-conducting core, wherein said shield is adapted to transmit a second information signal; and
at least one non-conducting insulator surrounding the at least one conductive shield;
wherein the multi-layered non-conducting dielectric core comprises a first layer of dielectric material and at least one additional layer of dielectric material, and said first layer of non-conducting dielectric material selected from a group consisting of polytetrafluoroethylene, fluorinated ethylene propylene, ethylene tetrafluoroethylene copolymer, perfluoroalkoxy copolymer, polyvinylidene fluoride, fluoropolymer, polyvinyl chloride, and polyurethane;
wherein the at least one additional layer of the multi-layered non-conducting core is selected from a group consisting of fluorinated ethylene propylene, ethylene tetrafluoroethylene copolymer, perfluoroalkoxy copolymer, polyvinylidene fluoride, fluoropolymer, polyvinyl chloride, and polyurethane;
wherein the at least one additional layer of the multi-layered non-conducting core is separable from the first layer of dielectric material.
